(19) United States
(12) Patent Application Publication
(10) Pub. No.: US 2014/0204175 A1
(43) Pub. Date: Jul. 24, 2014

(54) IMAGE CONVERSION METHOD AND MODULE FOR NAKED-EYE 3D DISPLAY

(71) Applicant: NATIONAL CHENG KUNG UNIVERSITY, TAINAN CITY (TW)

(72) Inventors: Jar-Ferr YANG, Tainan City (TW); Hung-Ming WANG, Tainan City (TW); Yi-Hsiang CHIU, Kaohsiung City (TW); Hung-Wei TSAI, Taichung City (TW)

(21) Appl. No.: 13/903,538

(22) Filed: May 28, 2013

(30) Foreign Application Priority Data
Jan. 18, 2013 (TW) 102102097

(51) Int. Cl. H04N 13/00

(52) U.S. Cl. CPC H04N 13/0011
USPC 348/43

(57) ABSTRACT

An image conversion method for naked-eye 3D display includes: an image receiving step to receive a 2D image data having a depth information; a sub-pixel arrangement receiving step to receive a sub-pixel arrangement data which is corresponding to a 3D display apparatus and includes a plurality of views; a view ascertaining step to ascertain the view corresponding to at least a sub-pixel of a plurality of sub-pixels by the sub-pixel arrangement data; and a sub-pixel data searching step to search a sub-pixel data of the sub-pixel at the ascertained view from the 2D image data by the depth information. Thereby, the sub-pixel data of these sub-pixels constitute a 3D image data for displaying.

### CROSS REFERENCE TO RELATED APPLICATIONS

This Non-provisional application claims priority under 35 U.S.C. §119(a) on Patent Application No(s). 102102097 filed in Taiwan, Republic of China on Jan. 18, 2013, the entire contents of which are hereby incorporated by reference.

### BACKGROUND OF THE INVENTION

1. Field of Invention

The invention relates to an image conversion method and module and, in particular to an image conversion method and module applied to the naked-eye 3D display.

2. Related Art

Recently, the technology of 3D display apparatuses is developed unceasingly. For the naked-eye 3D technology, a 3D display apparatus with a lenticular or barrier structure formed therein can transmit the images of different views to the left and right eyes of a user, respectively; so that the 3D images are produced in the user's brain due to the binocular parallax effect. Besides, with the progress of the display technology, the current 3D apparatus is able to display multi-view images so as to bring the more convenient viewing effect.

Besides, because of the lack of the originally produced video data, it is an important research how to convert the original 2D video data to the 3D image data for the use of the 3D display apparatus by the post-production.

In the middle of FIG. 1 is a sub-pixel arrangement pattern 101 of a 3D screen which is an 8-view screen for example, including the sub-pixels P11, P12, . . . , and the number put in each of the sub-pixels represents the corresponding view. Accordingly, eight image data V1˜V8 of different views shown in FIG. 1 are produced in the 3D screen.

As shown in FIG. 1, eight virtual image data V1˜V8 need to be produced first in the conventional method to be respectively corresponding to the different views, and these virtual image data are intended for the finally composed 3D image data. However, because every sub-pixel of the 3D image data only contains the image data of the single corresponding view, the finally composed image is actually derived from the one eighth portion of each of the virtual image data, and that is to say, the seven eighth portion of each of the virtual image data is wasted. Moreover, the virtual image data needs to be stored in the memory, so the hardware cost and the data processing time are increased with the increased size of the virtual image data and they will also be increased linearly with the increment of the views.

Furthermore, according to the different views, sub-pixel arrangement and image definition (such as the sub-pixel arrangement pattern 101 in FIG. 1 is changed), the hardware chip or display software often needs to be readjusted, so that the cost is increased while the product applicability is decreased.

Therefore, it is an important subject to provide an image conversion method and module applied to the naked-eye 3D display that can save the storage capacity and decrease the data processing time so that the cost can be decreased and the processing efficiency and product applicability can be improved.

### SUMMARY OF THE INVENTION

In view of the foregoing subject, an objective of the invention is to provide an image conversion method and module applied to the naked-eye 3D display that can save the storage capacity and decrease the data processing time.

To achieve the above objective, an image conversion method for naked-eye 3D display according to this invention includes steps of: an image receiving step to receive a 2D image data having a depth information; a sub-pixel arrangement receiving step to receive a sub-pixel arrangement data which is corresponding to a 3D display apparatus and includes a plurality of views; a view ascertaining step to ascertain the view corresponding to at least a sub-pixel of a plurality of sub-pixels by the sub-pixel arrangement data; and a sub-pixel data searching step to search a sub-pixel data of the sub-pixel at the ascertained view from the 2D image data by the depth information. Thereby, these sub-pixel data of these sub-pixels constitute a 3D image data for displaying.

In one embodiment, if a plurality of the sub-pixel data corresponding to a target sub-pixel at the ascertained view are found, the sub-pixel data with the largest depth is selected.

In one embodiment, the sub-pixel data searching step includes steps of: converting the depth information to a disparity information; and searching a sub-pixel data of the sub-pixel at the ascertained view from the 2D image data by the disparity information.

In one embodiment, the resolution of the 2D image data and that of the sub-pixel arrangement data are the same or different, and when they are different, the image conversion method can further comprise a resolution adjusting step to adjust the resolution of the 2D image data as the same as that of the sub-pixel arrangement data.

In one embodiment, the depth information is produced by a depth camera or an image processing procedure.

To achieve the above objective, an image conversion module applied to the naked-eye 3D display according to this invention comprises an image receiving unit, a sub-pixel arrangement receiving unit, a view ascertaining unit and a sub-pixel data searching unit. The image receiving unit receives a 2D image data having a depth information. The sub-pixel arrangement receiving unit receives a sub-pixel arrangement data which is corresponding to a 3D display apparatus and includes a plurality of views. The view ascertaining unit ascertains the view corresponding to at least one of a plurality of sub-pixels by the sub-pixel arrangement data. The sub-pixel data searching unit searches a sub-pixel data of the sub-pixel at the ascertained view from the 2D image data by the depth information. The all sub-pixel data of the all sub-pixels constitute a 3D image data for the display.

In one embodiment, if the sub-pixel data searching unit finds a plurality of the sub-pixel data corresponding to a target sub-pixel at the ascertained view, the sub-pixel data with the largest depth is selected.

In one embodiment, the sub-pixel data searching unit converts the depth information to a disparity information, and searches a sub-pixel data of the sub-pixel at the ascertained view from the 2D image data by the disparity information.

In one embodiment, the resolution of the 2D image data and that of the sub-pixel arrangement data are the same or different, and when they are different, the image conversion module can further comprise a resolution adjusting unit which adjusts the resolution of the 2D image data as the same as that of the sub-pixel arrangement data.

In one embodiment, the depth information is produced by a depth camera or an image processing procedure.

As mentioned above, during the image conversion of the image conversion method and module according to the embodiments of this invention, a plurality of the virtual image data corresponding to the all views are not produced, but instead the view of each of the sub-pixels is obtained and then the sub-pixel data of the all sub-pixels can be obtained from the 2D image data by the depth information. Thereby, the sub-pixel data of the all sub-pixels can be obtained and constitute the 3D image data for the display even though the virtual image data with a quantity the same as the views are never produced. Therefore, the required storage capacity of memory and the data processing time will be kept even if the views are increased so that the cost and processing time can be saved and decreased.

Besides, the image conversion method and module applied to the naked-eye 3D display according to this invention can receive the sub-pixel arrangement data of different 3D display apparatuses so that they can be applied to different kinds of 3D display apparatuses, and thereby the application scope and competitiveness of the product can be increased.

### BRIEF DESCRIPTION OF THE DRAWINGS

The invention will become more fully understood from the detailed description and accompanying drawings, which are given for illustration only, and thus are not limitative of the present invention, and wherein;

FIG. 1 is a schematic diagram showing a conventional method wherein a plurality of virtual image data need to be produced corresponding to the respective views;

FIG. 2 is a flow chart of an image conversion method applied to the naked-eye 3D display according to a preferred embodiment of the invention;

FIGS. 3A and 3B are schematic diagrams of a 2D image data having a depth information;

FIGS. 4A and 4B are schematic diagrams of two exemplary embodiments of the sub-pixel arrangement data;

FIGS. 5A to 5C are schematic diagrams for illustrating the sub-pixel data searching step according to a preferred embodiment of the invention;

FIGS. 6A and 6B are schematic diagrams for illustrating the sub-pixel data searching step according to another preferred embodiment of the invention;

FIG. 7 is a flow chart of a practical application of the image conversion method according to a preferred embodiment of the invention; and

FIG. 8 is a block diagram of an image conversion module applied to the naked-eye 3D display according to a preferred embodiment of the invention.

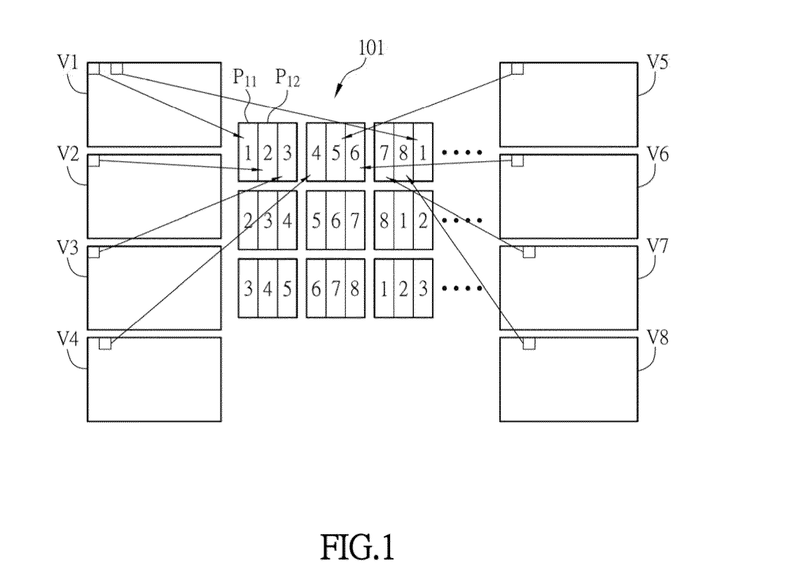

### DETAILED DESCRIPTION OF THE INVENTION

The present invention will be apparent from the following detailed description, which proceeds with reference to the accompanying drawings, wherein the same references relate to the same elements.

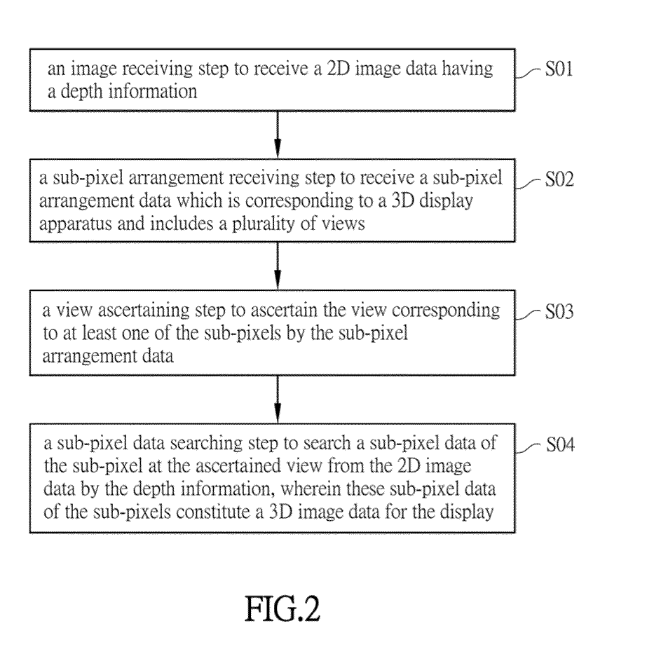

FIG. 2 is a flow chart of an image conversion method applied to the naked-eye 3D display according to a preferred embodiment of the invention, including the steps S01˜S04. The invention is with regard to converting 2D image data to 3D image data whereby a naked-eye 3D display apparatus can display 3D images.

The step S01 is an image receiving step to receive a 2D image data having a depth information. In the field of digital image processing, one of the methods to show the distance of an object is to use the depth image. The depth image is a gray level image having the same resolution as the original image, and the value of each of the pixels represents the relative distance between the pixel and the viewer. The farthest distance is represented by the value of 0, and the nearest distance is represented by the value of 255, for example.

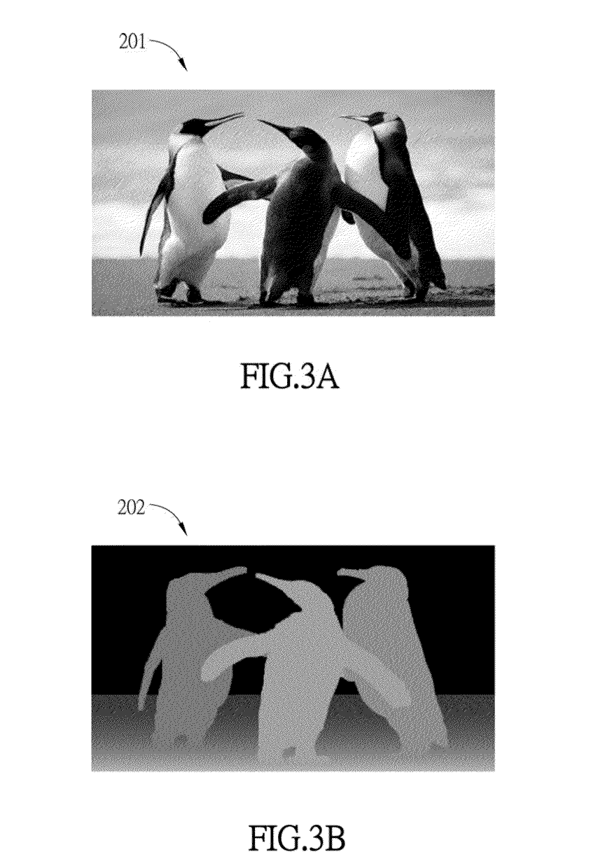

FIGS. 3A and 3B are schematic diagrams of a 2D image data having a depth information. FIG. 3A is a colorful image 201, representing 2D image data and including gray level data of each of the sub-pixels. FIG. 3B is a depth image 202, including the depth information. In this embodiment, the depth information can be produced by a depth camera or an image processing procedure.

The step S02 is a sub-pixel arrangement receiving step to receive a sub-pixel arrangement data which is corresponding to a 3D display apparatus and includes a plurality of views. The number of views and the sub-pixel arrangement pattern of different display apparatuses may be different, and even pixels or sub-pixels thereof contain different view information. In this embodiment, the sub-pixel arrangement is regarded as a variable and the image conversion method can receive a sub-pixel arrangement data, so that the application scope of the invention is broadened. Therefore, the image conversion method of this invention can be suitably applied to the 3D display apparatuses having different sub-pixel arrangement patterns.

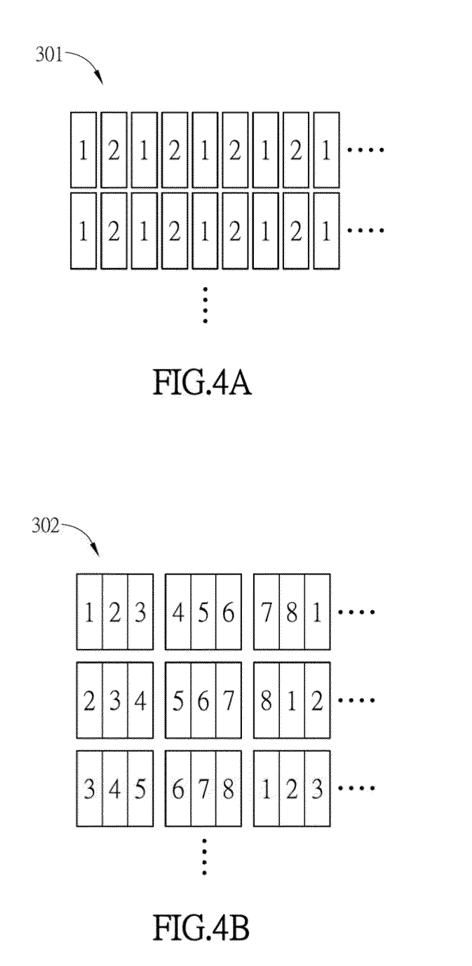

FIGS. 4A and 4B are schematic diagrams of two exemplary embodiments of the sub-pixel arrangement data. FIG. 4A schematically shows a sub-pixel arrangement data 301 having two views and a resolution of 1024*768. In FIG. 4A, a pixel includes three sub-pixels, and the all sub-pixels are corresponding to the two views (represented by the numbers of 1 and alternately. FIG. 4B schematically shows a sub-pixel arrangement data 302 having eight views and a resolution of 1920*1080. In FIG. 4B, a pixel includes three sub-pixels, and the all sub-pixels are corresponding to the eight views (represented by the numbers of 1˜8) alternately.

The step S03 is a view ascertaining step to ascertain the view corresponding to at least one of the sub-pixels by the sub-pixel arrangement data. For the 8-view display in FIG. 4B as an example, after the sub-pixel arrangement data is received, the view corresponding to each of the sub-pixels can be ascertained, as represented by the number put in the sub-pixel in FIG. 4B, by the sub-pixel arrangement data.

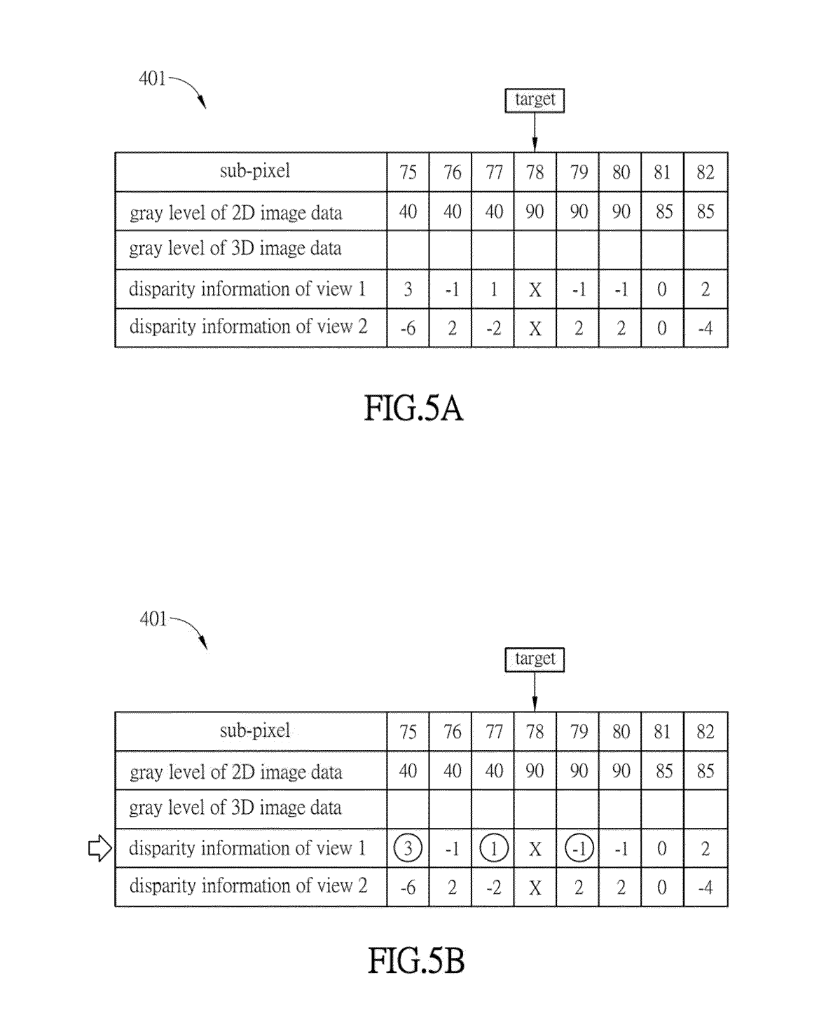

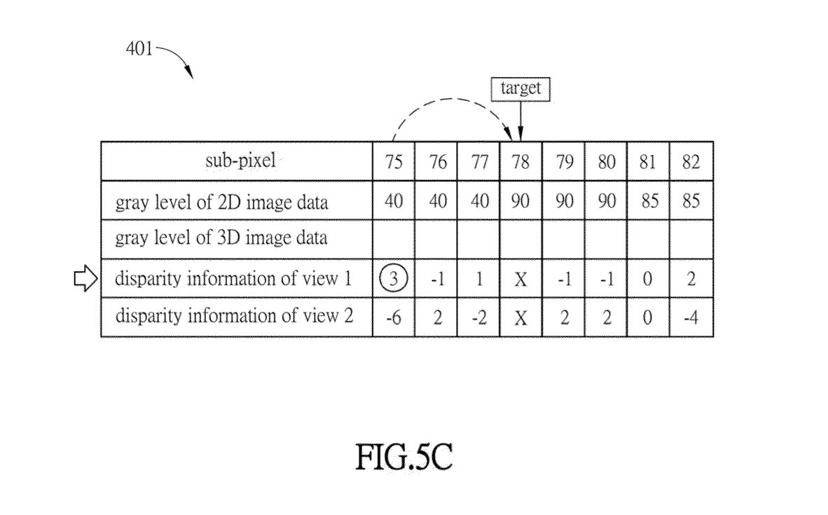

The step S04 is a sub-pixel data searching step to search a sub-pixel data of the sub-pixel at the ascertained view from the 2D image data by the depth information, wherein these sub-pixel data of the sub-pixels constitute a 3D image data for the display. The 3D image data finally produced includes a plurality of sub-pixels. For an example of the resolution of 1920*1080, the number of the sub-pixels is 6220800 (1920*1080*3). The sub-pixel data of the all sub-pixels of the 3D image data are distributed among eight view images (for an example of the 8-view display), but these eight view images are not produced in this invention. Instead, the 3D image data is derived by searching the received 2D image data and using the depth information. The sub-pixel data searching step is illustrated as below by FIGS. 5A to 5C.

FIG. 5A shows a relationship table 401 of the sub-pixel of the 3D image data and the sub-pixel of the view 1. The sub-pixel “78” is corresponding to the view 1 (obtained from the view ascertaining step), and that is, the sub-pixel data of the sub-pixel “78” of the 3D image data needs to be obtained from the sub-pixel data of the 2D image data of the view 1. To be noted, the gray level of the sub-pixel “78” of the 2D image data is 90, but it is not the data of the sub-pixel “78” of the 3D image data because the sub-pixel “78” is corresponding to the 2D image data at the view 1. That is to say, which sub-pixel of the 2D image data will reach the sub-pixel “78” after being converted to the view 1 has the required sub-pixel data of the sub-pixel “78” of the 3D image data.

Herein, the sub-pixel data searching step can includes steps of: converting the depth information to a disparity information; and searching a sub-pixel data of the sub-pixel at the ascertained view from the 2D image data by the disparity information. As shown in FIG. 5A, the disparity information of the all sub-pixels at the view 1 can be obtained after the conversion. Then, as shown in FIG. 5B, the fit disparity information at the view 1 includes 3 (the sub-pixel “75”), 1 (the sub-pixel “77”) and −1 (the sub-pixel “79”) found in the sub-pixel data searching step. This means the sub-pixels “75”, “77” and “79” of the 2D image data are all corresponding to the sub-pixel “78” of the 3D image data after being converted to the view 1. In this embodiment, if a plurality of sub-pixel data are found corresponding to the target sub-pixel at the ascertained view, the sub-pixel data with the largest depth is selected. In other words, although three sub-pixels can all reach the target sub-pixel at the view 1, only one sub-pixel, of the largest depth, can be selected. Herein, the largest depth is corresponding to the disparity information having the largest absolute value, and thus the sub-pixel “75” (having the largest absolute value of 3) with the gray level of 40 of the 2D image data is selected in this embodiment. Therefore, as shown in FIG. 5C, the gray level of the sub-pixel “78” of the 3D image data is 40.

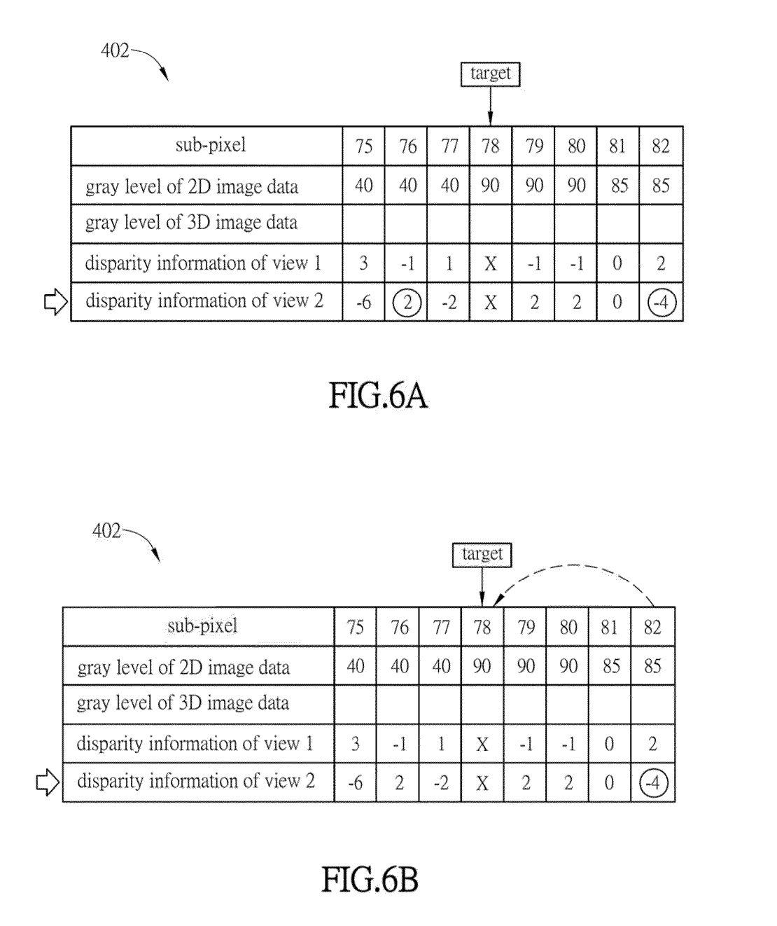

FIGS. 6A and 6B show another instance. FIG. 6A shows a relationship table 402 of the sub-pixel of the 3D image data and the sub-pixel of the view 2. For this embodiment, the sub-pixel “78” is supposed to be corresponding to the view 2 (also obtained from the view ascertaining step). As shown in FIG. 6A, the fit disparity information of the view 2 includes 2 (the sub-pixel “76”) and −4 (the sub-pixel “82”) found in the sub-pixel data searching step. This means the sub-pixels “76” and “82” of the 2D image data are both corresponding to the sub-pixel “78” of the 3D image data after being converted to the view 2. Likewise, if a plurality of sub-pixel data are found corresponding to the target sub-pixel at the ascertained view, the sub-pixel data with the largest depth is selected. Herein, the largest depth is corresponding to the disparity information having the largest absolute value, and thus the sub-pixel “82” (having the largest absolute value of 4) with the gray level of 85 of the 2D image data is selected in this embodiment. Therefore, as shown in FIG. 6B, the gray level of the sub-pixel “78” of the 3D image data is 85.

The above embodiments are just for example, but not for limiting the scope of this invention. The sub-pixel data of the rest sub-pixels of the 3D image data can be all obtained likewise, and then the sub-pixel data of the all sub-pixels can constitute a 3D image data for the display.

Besides, the resolution of the 2D image data and that of the sub-pixel arrangement data can be the same or different, and when they are different, the image conversion method can further include a resolution adjusting step to adjust the resolution of the 2D image data as the same as that of the sub-pixel arrangement data. For example, if the resolution of the 2D image data is 1024*768 while that of the sub-pixel arrangement data is 1920*1080, the resolution of the 2D image data can be upscaled to 1920*1080 and the view ascertaining step and sub-pixel data searching step are executed subsequently.

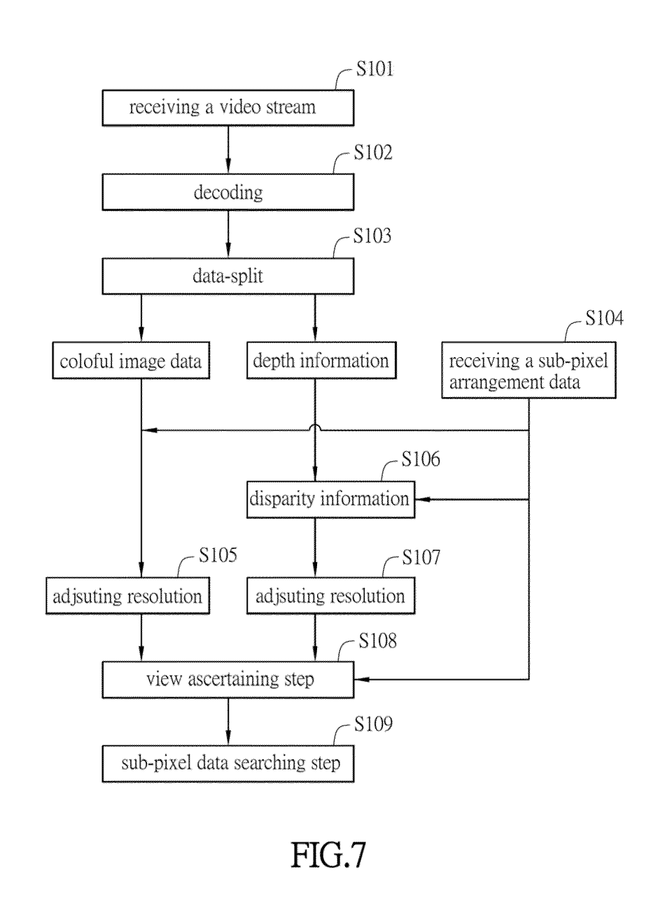

FIG. 7 is a flow chart of a practical application of the image conversion method according to a preferred embodiment of the invention. First, a video stream is received (S101) in the image receiving step, including 2D image data having depth information. Then, the video stream is decoded (S102) and data-split (S103) for obtaining a colorful image data (as shown in FIG. 3A for example) and a depth information (as shown in FIG. 3B for example). Then, a sub-pixel arrangement data is received (S104) in the sub-pixel arrangement receiving step, including the screen type, resolution, sub-pixel arrangement pattern (as shown in FIG. 4A or 4B) and so on. If the resolution of the colorful image data is different from that of the sub-pixel arrangement data, the resolution is adjusted (S105) to make their resolutions the same. Besides, the depth information is converted to the disparity information (S106). The resolution of the disparity information may be also adjusted (S107). After adjusting the resolution, the view ascertaining step (S108) and the sub-pixel data searching step (S109) are executed successively to obtain the sub-pixel data of the all sub-pixels of the 3D image data for the display.

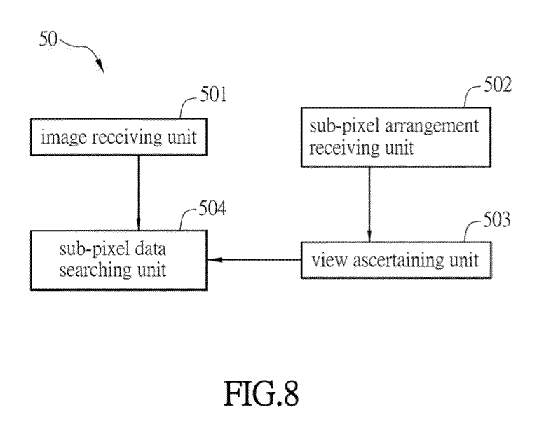

FIG. 8 is a block diagram of an image conversion module 50 applied to the naked-eye 3D display according to a preferred embodiment of the invention. In FIG. 8, the image conversion module 50 includes an image receiving unit 501, a sub-pixel arrangement receiving unit 502, a view ascertaining unit 503 and a sub-pixel data searching unit 504.

The image receiving unit 501 receives a 2D image data having a depth information which can be produced by a depth camera or an image processing procedure. The sub-pixel arrangement receiving unit 502 receives a sub-pixel arrangement data which is corresponding to a 3D display apparatus and includes a plurality of views. The view ascertaining unit 503 ascertains the view corresponding to at least one of the sub-pixels of a 3D image data by the sub-pixel arrangement data. The sub-pixel data searching unit 504 searches a sub-pixel data of the sub-pixel at the ascertained view from the 2D image data by the depth information, and the all sub-pixel data of the all sub-pixels constitute a 3D image data for the 3D display.

If the sub-pixel data searching unit 504 finds a plurality of the sub-pixel data corresponding to a target sub-pixel at the ascertained view, the sub-pixel data with the largest depth is selected.

The sub-pixel data searching unit 504 converts the depth information to a disparity information, and searches a sub-pixel data of the sub-pixel at the ascertained view from the 2D image data by the disparity information.

The resolution of the 2D image data and that of the sub-pixel arrangement data can be the same or different, and when they are different, the image conversion module 50 can further includes a resolution adjusting unit, which adjusts the resolution of the 2D image data as the same as that of the sub-pixel arrangement data.

The other technical features of the image conversion module 50 are clearly illustrated in the above embodiments of the image conversion method, and therefore they are not described here for conciseness.

In summary, during the image conversion of the image conversion method and module according to the embodiments of this invention, a plurality of the virtual image data corresponding to the all views are not produced, but instead the view of each of the sub-pixels is obtained and then the sub-pixel data of the all sub-pixels can be obtained from the 2D image data by the depth information. Thereby, the sub-pixel data of the all sub-pixels can be obtained and constitute the 3D image data for the display even though the virtual image data with a quantity the same as the views are never produced. Therefore, the required storage capacity of memory and the data processing time will be kept even if the views are increased so that the cost and processing time can be saved and decreased.

Besides, the image conversion method and module applied to the naked-eye 3D display according to this invention can receive the sub-pixel arrangement data of different 3D display apparatuses so that they can be applied to different kinds of 3D display apparatuses, and thereby the application scope and competitiveness of the product can be increased.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An image conversion method applied to the naked-eye 3D display, comprising:
an image receiving step to receive a 2D image data having a depth information;
a sub-pixel arrangement receiving step to receive a sub-pixel arrangement data which is corresponding to a 3D display apparatus and includes a plurality of views;
a view ascertaining step to ascertain the view corresponding to at least a sub-pixel of a plurality of sub-pixels by the sub-pixel arrangement data; and
a sub-pixel data searching step to search a sub-pixel data of the sub-pixel at the ascertained view from the 2D image data by the depth information.

2. The image conversion method as recited in claim 1, wherein if a plurality of the sub-pixel data corresponding to a target sub-pixel at the ascertained view are found, the sub-pixel data with the largest depth is selected.

3. The image conversion method as recited in claim 1, wherein the sub-pixel data searching step includes steps of:
converting the depth information to a disparity information; and
searching a sub-pixel data of the sub-pixel at the ascertained view from the 2D image data by the disparity information.

4. The image conversion method as recited in claim 1, wherein the resolution of the 2D image data and that of the sub-pixel arrangement data are the same or different.

5. The image conversion method as recited in claim 4, further comprising:
a resolution adjusting step to adjust the resolution of the 2D image data as the same as that of the sub-pixel arrangement data.

6. The image conversion method as recited in claim 1, wherein the depth information is produced by a depth camera or an image processing procedure.

7. An image conversion module applied to the naked-eye 3D display, comprising:
an image receiving unit receiving a 2D image data having a depth information;
a sub-pixel arrangement receiving unit receiving a sub-pixel arrangement data which is corresponding to a 3D display apparatus and includes a plurality of views;
a view ascertaining unit ascertaining the view corresponding to at least one of a plurality of sub-pixels by the sub-pixel arrangement data; and
a sub-pixel data searching unit searching a sub-pixel data of the sub-pixel at the ascertained view from the 2D image data by the depth information, wherein the all sub-pixel data of the all sub-pixels constitute a 3D image data for the display.

8. The image conversion module as recited in claim 7, wherein if the sub-pixel data searching unit finds a plurality of the sub-pixel data corresponding to a target sub-pixel at the ascertained view, the sub-pixel data with the largest depth is selected

9. The image conversion module as recited in claim 7, wherein the sub-pixel data searching unit converts the depth information to a disparity information, and searches a sub-pixel data of the sub-pixel at the ascertained view from the 2D image data by the disparity information.

10. The image conversion module as recited in claim 7, wherein the resolution of the 2D image data and that of the sub-pixel arrangement data are the same or different.

11. The image conversion module as recited in claim 10, further comprising:
a resolution adjusting unit adjusting the resolution of the 2D image data as the same as that of the sub-pixel arrangement data.

12. The image conversion module as recited in claim 7, wherein the depth information is produced by a depth camera or an image processing procedure.
